(19) United States
(12) Patent Application Publication
(10) Pub. No.: US 2002/0193247 A1
(43) Pub. Date: Dec. 19, 2002

(54) Autothermal hydrodesulfurizing reforming catalyst

(76) Inventors: Michael Krumpelt, Naperville, IL (US); John P. Kopasz, Bolingbrook, IL (US); Shabbir Ahmed, Naperville, IL (US); Richard Li-chih Kao, Northbrook, IL (US); Sarabjit Singh Randhava, Evanston, IL (US)

Correspondence Address: Thomas W. Tolpin, Welsh & Katz LTD., 22nd Floor, 120 S. Riverside Plaza, Chicago, IL, 60606, US

(21) Appl. No.: 09/860,850

(22) Filed: May 18, 2001

(51) Int. Cl. B01J 27/053

(52) U.S. Cl. 502/302; 502/328; 502/330; 502/217

(57) ABSTRACT

A multi-part catalyst composition having a dehydrogenation portion, an oxidation portion and a hydrodesulfurization portion. The catalyst composition is suitable for reforming a sulfur-containing carbonaceous fuel.

### BACKGROUND OF THE INVENTION

1. Field of the Invention

This invention relates to a catalyst for reforming a sulfur-containing carbonaceous fuel to produce a hydrogen-rich gas suitable for use in fuel cell power generating systems or other systems which generally are not sulfur-tolerant and a method for reforming a sulfur-containing carbonaceous fuel employing said catalyst. The catalyst is a multi-part reforming catalyst comprising a dehydrogenation portion, an oxidation portion and a hydrodesulfurization portion.

2. Description of Prior Art

A fuel cell is an electrochemical device comprising an anode electrode, a cathode electrode and an electrolyte disposed between the anode electrode and the cathode electrode. Individual fuel cells or fuel cell units typically are stacked with bipolar separator plates separating the anode electrode of one fuel cell unit from the cathode electrode of an adjacent fuel cell unit to produce fuel cell stacks. There are four basic types of fuel cells, molten carbonate, phosphoric acid, solid oxide and polymer electrolyte membrane. Fuel cells typically consume a gaseous fuel and generate electricity.

Substantial advancements have been made during the past several years in fuel cells for transportation, stationary and portable power generation applications. These advancements have been spurred by the recognition that these electrochemical devices have the potential for high efficiency and lower emissions than conventional power producing equipment. Increased interest in the commercialization of polymer electrolyte membrane fuel cells, in particular, has resulted from recent advances in fuel cell technology, such as the 100-fold reduction in the platinum content of the electrodes and more economical bipolar separator plates.

Ideally, polymer electrolyte membrane fuel cells operate with hydrogen. In the absence of a viable hydrogen storage option or a near-term hydrogen-refueling infrastructure, it is necessary to convert available fuels, typically CₓH_{y} and CₓH_{y}O_{z}, collectively referred to herein as carbonaceous fuels, with a fuel processor into a hydrogen-rich gas suitable for use in fuel cells. The choice of fuel for fuel cell systems will be determined by the nature of the application and the fuel available at the point of use. In transportation applications, it may be gasoline, diesel, methanol or ethanol. In stationary systems, it is likely to be natural gas or liquified petroleum gas. In certain niche markets, the fuel could be ethanol, butane or even biomass-derived materials. In all cases, reforming of the fuel is necessary to produce a hydrogen-rich fuel.

There are basically three types of fuel processors—steam reformers, partial oxidation reformers and autothermal reformers. Most currently available fuel processors employing the steam reforming reaction are large, heavy and expensive. For fuel cell applications such as in homes, mobile homes and light-duty vehicles, the fuel processor must be compact, lightweight and inexpensive to build/manufacture and it should operate efficiently, be capable of rapid start and load following, and enable extended maintenance-free operation.

Partial oxidation and autothermal reforming best meet these requirements. However, it is preferred that the reforming process be carried out catalytically to reduce the operating temperature, which translates into lower cost and higher efficiency, and to reduce reactor volume. U.S. Pat. No. 6,110,861 to Krumpelt et al. teaches a two-part catalyst comprising a dehydrogenation portion and an oxide-ion conducting portion for partially oxidizing carbonaceous fuels such as gasoline to produce a high percentage yield of hydrogen suitable for supplying a fuel cell. The dehydrogenation portion of the catalyst is a Group VIII metal and the oxide-ion conducting portion is selected from a ceramic oxide crystallizing in the fluorite or perovskite structure. However, reforming catalysts, which are often Ni-based, are poisoned by sulfur impurities in the carbonaceous fuels, thereby requiring the addition of a hydrodesulfurization step or a sulfur adsorption bed to the fuel processor upstream of the reforming step. This is due to the adsorption of sulfur on the active metal catalyst sites. Sulfur also tends to increase coking rates, which leads to further degradation of the reforming catalysts and unacceptable catalyst performance.

Other methods for addressing this problem are known, such as U.S. Pat. No. 5,336,394 to Iino et al. which teaches a process for hydrodesulfurizing a sulfur-containing hydrocarbon in which the sulfur-containing hydrocarbon is contacted in the presence of hydrogen with a catalyst composition comprising a Group VIA metal, a Group VIII metal and an alumina under hydrodesulfurizing conditions and U.S. Pat. No. 5,270,272 to Galperin et al. which teaches a sulfur-sensitive conversion catalyst suitable for use in a reforming process in which the feedstock contains small amounts of sulfur and a method for regeneration of the catalyst. The catalyst comprises a non-acidic large-pore molecular sieve, for example, L-zeolite, an alkali-metal component and a platinum-group metal component. In addition, it may include refractory inorganic oxides such as alumina, silica, titania, magnesia, zirconia, chromia, thoria, boria or mixtures thereof, synthetically or naturally occurring clays and silicates, crystalline zeolitic aluminosilicates, spinels such as MgAl₂O₄, FeAl₂O₄, ZnAl₂O₄, CaAl₂O₄, and combinations thereof The catalyst may also contain other metal components known to modify the effect of the preferred platinum component, such as Group IVA (14) metals, non-noble Group VIII (8-10) metals, rhenium, indium, gallium, zinc, uranium, dysprosium, thallium and mixtures thereof. However, such known methods frequently require an additional step such as regeneration of the catalyst.

### SUMMARY OF THE INVENTION

Accordingly, it is one object of this invention to provide an improved catalyst for conversion of sulfur-containing carbonaceous fuel to hydrogen-rich gas.

It is another object of this invention to provide a catalyst for conversion of sulfur-containing carbonaceous fuel to hydrogen-rich gas which does not require regeneration.

These and other objects of this invention are addressed by a catalyst composition comprising a dehydrogenation portion, an oxidation portion and a hydrodesulfurization portion. The catalyst converts the carbonaceous fuels at temperatures less than about 1000° C. to a hydrogen-rich gas suitable for use in fuel cell power generating systems. Performance of the catalyst is not degraded and the catalyst is not poisoned by sulfur impurities in the fuels. The sulfur impurities, even complex benzothiophenes, are converted to hydrogen sulfide, hydrogen and carbon dioxide. If necessary, the hydrogen sulfide can then be adsorbed on a zinc-oxide bed.

In accordance with one preferred embodiment of this invention, the dehydration portion of the catalyst composition comprises a metal or metal alloy selected from the group consisting of Group VIII transition metals and mixtures thereof. Preferably, the oxidation portion of the catalyst composition comprises a ceramic oxide powder and a dopant selected from the group consisting of rare earth metals, alkaline earth metals, alkali metals and mixtures thereof. Preferably, the hydrodesulfurization portion of the catalyst composition comprises a material selected from the group consisting of Group IV rare earth metal sulfides, Group IV rare earth metal sulfates, their substoichiometric metals and mixtures thereof.

### BRIEF DESCRIPTION OF THE DRAWINGS

These and other objects and features of this invention will be better understood from the following detailed description taken in conjunction with the drawings wherein:

FIG. 1 is a diagram showing the effect of sulfated fuel on product gas composition using a catalyst (Catalyst 1) in accordance with one embodiment of this invention;

FIG. 2 is a diagram showing the time delay increase in hydrogen content in the product gas during sulfation of Catalyst 1 by sulfated fuel;

FIG. 3 is a diagram showing the long-term performance of Catalyst 1 with a sulfur-laden blended gasoline;

FIG. 4 is a diagram showing the effect of sulfur levels in diesel fuel on product gas composition using a catalyst in accordance with one embodiment of this invention different from Catalyst 1 (Catalyst 2);

FIG. 5 is a diagram showing the effect of sulfur content in blended gasoline on product gas composition using Catalyst 1;

FIG. 6 is a diagram showing a comparison of the effect of sulfur content in isooctane on product gas between Catalyst 1 and Catalyst 2;

FIG. 7 is a diagram showing the effect of sulfur levels on product gas composition over a presulfated Catalyst 2;

FIG. 8 is a diagram showing the effect of sulfur levels on sums of H₂ and CO in product gas composition over the presulfated Catalyst 2; and

FIG. 9 is a diagram showing product gas composition of pure and doped isooctane over pure and presulfated Catalyst 2.

### DETAILED DESCRIPTION OF THE PRESENTLY PREFERRED EMBODIMENTS

Sulfur impurities in carbonaceous fuels such as gasoline, diesel fuel, or natural gas, cause major problems for reforming these fuels to hydrogen-rich gas for use in fuel cell power generating systems or other purposes. The sulfur impurities poison the reforming catalysts, as well as other catalysts in the processing stream and catalysts in the fuel cells. Poisoning is generally due to adsorption of sulfur to the active metal catalyst sites. In addition, sulfur impurities increase the coking seen in the reforming catalysts, accelerating a second mechanism for degradation of the catalysts. In order to obtain a hydrogen-rich gas, the sulfur-containing carbonaceous fuels must first be desulfurized. This is generally achieved using hydrodesulfurization, which consumes some of the hydrogen produced. Adsorption processes are alternatives, but are generally less effective than hydrodesulfurization due to the complex nature of the sulfur impurities in diesel and gasoline fuels. The sulfur is in the form of thiols, thiophenes, and benzothiophenes. The organic functions make it difficult to absorb the sulfur-containing species preferentially.

In accordance with the present invention, a sulfur tolerant and coking resistant catalyst is used to reform the sulfur-laden carbonaceous fuels prior to sulfur removal. The sulfur impurities are cracked or reformed to H₂S, CO₂ and H₂ in an autothermal hydrodesulfurizing reformer. The H₂S can then be preferentially adsorbed on a zinc-oxide bed after the reformer, if necessary. This increases the overall efficiency of the fuel processor by eliminating the hydrodesulfurization or the sulfur adsorption step prior to the reformer.

The catalyst of this invention, which is suitable for use in reforming sulfur-laden carbonaceous fuels, is a multi-part catalyst comprising a dehydrogenation portion, an oxidation portion and a hydrodesulfurization portion. The dehydrogenation portion of the catalyst is selected from Group VIII transition metals and mixtures thereof. The oxidation portion of the catalyst in accordance with one preferred embodiment of this invention is a ceramic oxide powder including one or more of ZrO₂, CeO₂, Bi₂O₃, BiVO₄, LaGdO₃ and a dopant selected from the group consisting of rare earths, the alkaline earth and alkali metals. The hydrodesulfurization portion of the catalyst in accordance with one preferred embodiment of this invention comprises sulfides or sulfates of the rare earths (e.g., Ce(SO₄)₂), Group IV (e.g., TiS₂, ZrS₂, Zr(SO₄)₂) and their substoichiometric metals (e.g., MSₓ, where x<2, such as Ti(SO₄)_{1.5}, GdS_{1.5}, LaS_{1 5}) which are more stable than the Group VIII metal sulfides. This is due to the higher strength of the metal-sulfur bonds compared to those for the Group VIII metals. The metal-sulfur bonds in these materials have bond strengths greater than 100 kcal/mol (e.g. 100, 136, 138 kcal/mol for Ti, Ce, and Zr—S bonds compared to 77, 79, 82 kcal/mol for Fe, Co, and Ni—S bonds).

By way of example, a ceramic oxide such as gadolinium doped ceria (Ce_{0.8}Gd_{0.2}O_{1.9}) as the oxidation material and a Group VIII transition metal such as platinum as the dehydrogenation metal were chosen for the catalyst. Nitrates of Ce, Gd and Pt and glycine were dissolved in water and the resulting solution heated. As a result of heating, water in the solution was evaporated, resulting in a self-sustaining combustion of the material. The resulting powder was dry-milled for 3-4 hours to reduce the size of agglomerates. The doped ceria powder (50-70 wt %) was mixed with 1-5 wt % stearic acid, 1-5 wt % graphite, 1-5 wt % methocellulose binder mixture and 10-30 wt % distilled water. The powder mixture was then fed into an extruder by which extrudates in the form of a hard and continuous string were generated. After extrusion, the catalyst was fired at 1000° C. in air for 15 to 60 minutes. The presulfated catalyst is obtained by treating the catalyst with dilute sulfuric acid (about 10% concentration), annealed in air at about 175° C. for about 16 hours and then 300° C. for two hours, and finally heat treated in helium up to about 800° C. for about one hour before being used in tests. The sulfur content of the presulfated catalyst was determined to be about 5.5 wt %. If the sulfur is present as a sulfide rather than a sulfate or sulfite, the corresponding catalyst composition would be 0.5 wt % Pt on Ce_{0.8}Gd_{0.2}O_{0.16}S_{0.3}. It should be noted that sulfation of the catalyst may also be accomplished with a sulfated fuel. After the reforming of isooctane doped with 1,000 wppm S, the sulfur content in the catalyst was 0.04 wt %, which corresponds to a catalyst composition comprising Ce_{0.8}Gd₂O_{1.898}SO0.002. In the examples set forth hereinbelow, the size of the catalyst particles used was in the range of about 20 mesh to about 35 mesh (about 0.0331 to about 0.0197 inches). For commercial applications, the mixture would be pressed or extruded into 1.125 to 1.5 inch pellets before firing at 1000° C. for about 15 minutes to about 60 minutes in air.

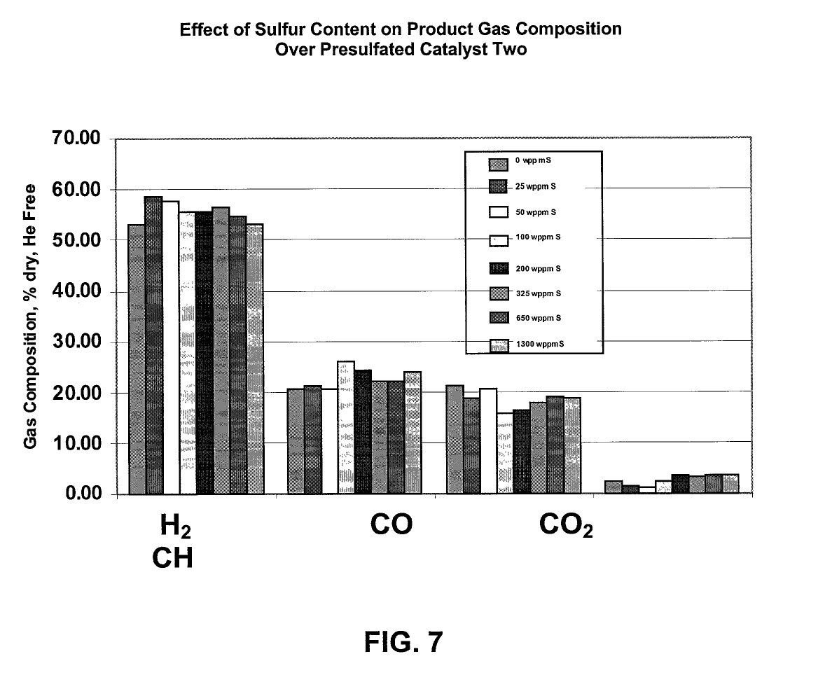

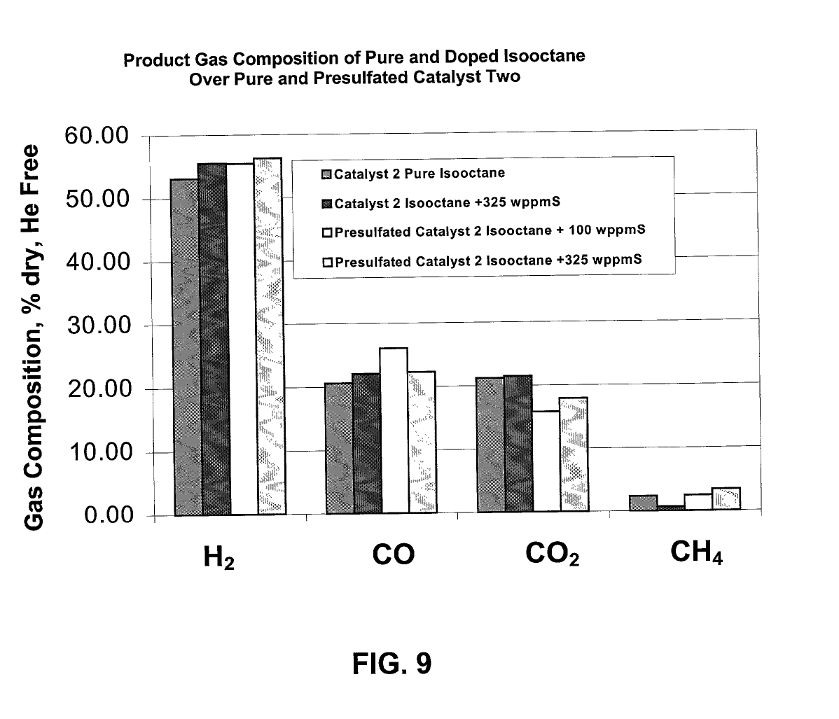

The ceramic oxide can also be doped, if desired, with additional rare earth metals such as samarium (Sm) plus additional alkali and alkaline earth metals, such as lithium (Li), cesium (Cs) and sodium (Na). Test results using a 0.5% by weight Pt on Ce_{0.75}Sm_{0.234}Cs_{0.015}Li_{0.001}O_{1 54}S_{0.32} presulfated multi-part catalyst in accordance with one embodiment of this invention on isooctane doped with benzothiophene versus pure isooctane are shown in FIGS. 7 and 9.

The following examples are presented for the purpose of demonstrating the advantages of the catalyst composition of this invention over known catalyst compositions and are in no way intended to limit or otherwise reduce the scope of the invention claimed herein. In these examples, two autothermal hydrodesulfurizing reforming catalysts were used as follows: Catalyst 1-0.5 wt % Pt on Ce_{0.8}Gd_{0 2}O_{1.9}; presulfated Catalyst 1-0.5 wt % Pt on Ce_{0.8}Gd_{0.2}O_{1 6}S_{0.3}; Catalyst 2-0.5 wt % Pt on Ce_{0.75}Sm_{0.234}CS_{0.015}Li_{0.001}O_{1.86}; and presulfated Catalyst 2-0.5 wt % Pt on Ce_{0.75}Sm_{0.234}Cs_{0 015}Li_{0.001}O_{1.54}S_{0.32}. The sulfur tolerance and coking resistance of Catalyst 1 are illustrated with a 50 wppm sulfur level blended gasoline in Example 1; with diesel fuel with sulfur levels of 244 and 488 wppm over Catalyst 2 in Example 2; and improved hydrogen yield from autothermal hydrosulfurizing and reforming a sulfur-laden carbonaceous fuel compared with the same unsulfated carbonaceous fuel over catalysts of this invention are illustrated in Examples 3 and 4.

### EXAMPLE 1

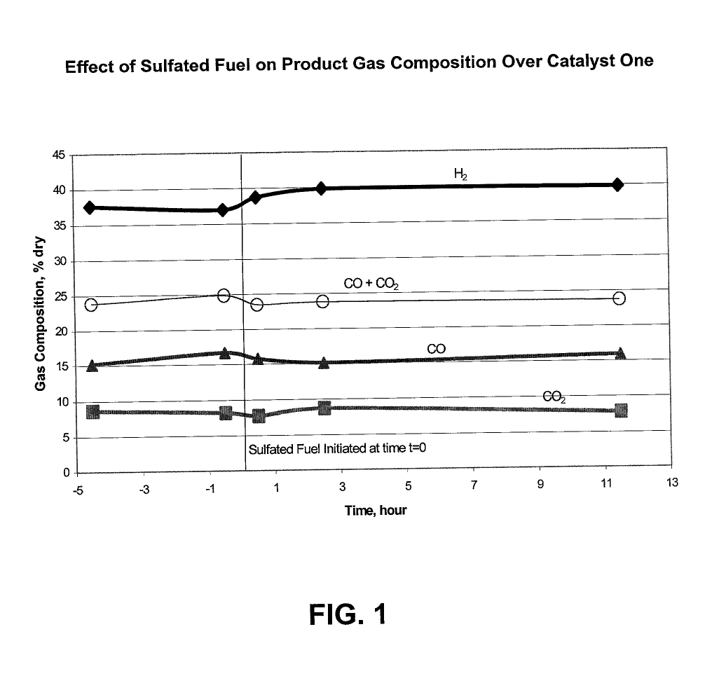

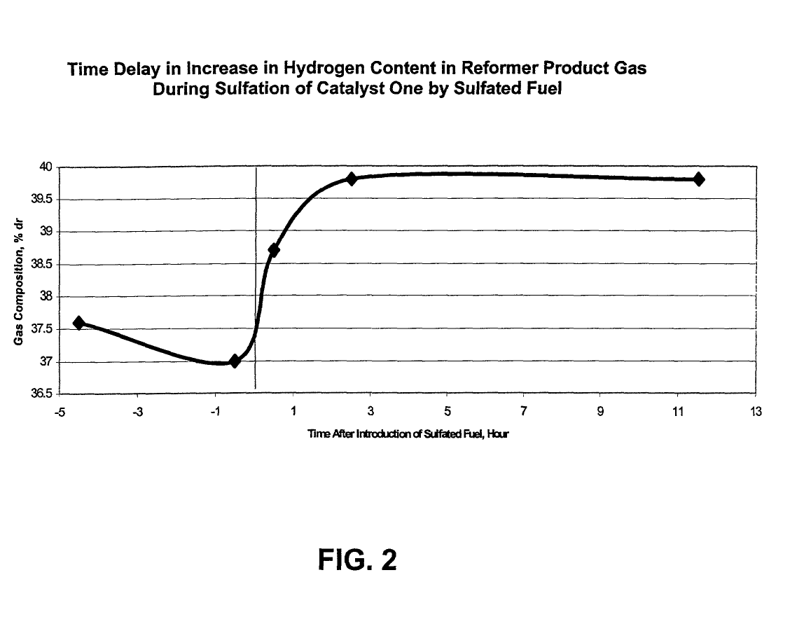

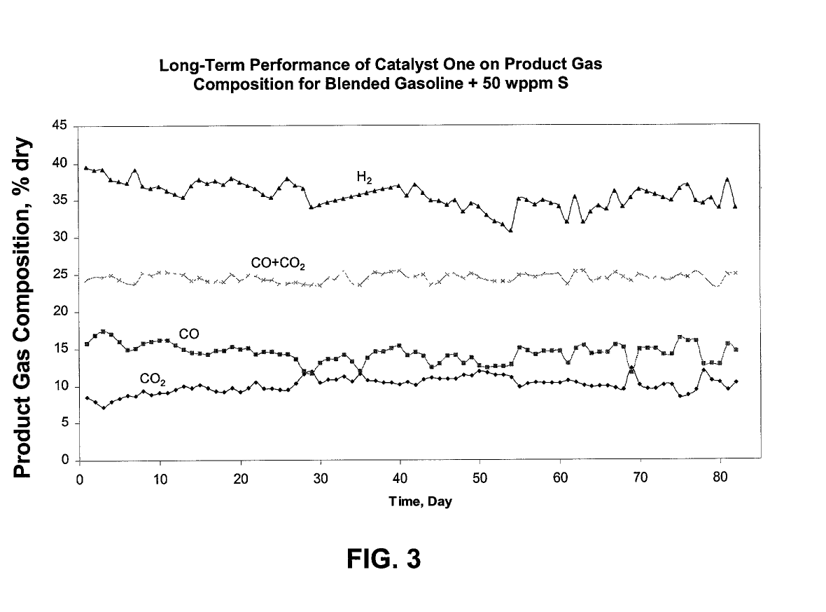

This example illustrates the sulfur tolerance and coking resistance of a catalyst composition in accordance with one embodiment of this invention with a 50 wppm sulfur level blended gasoline. 20 g of Catalyst 1 were placed in a 16″ long 0.34″ internal diameter tubular reactor. The catalyst occupied 8″ of the length and was located roughly in the center of the tubular reactor. The temperatures in the catalyst bed were maintained in the range of about 760 to 800° C., and the pressure was maintained at about 5 psig. The flow rates were: 0.2 ml/min carbonaceous fuel, 0.3 ml/min H₂O and 515 sccm air. The carbonaceous fuel was a blended gasoline containing 74% by weight isooctane, 20% by weight xylene, 5% by weight methyl cyclohexane and 1% by weight pentene. At −4.5 hours, the operation starts with a pure blended gasoline feed, and at time zero, benzothiophene is introduced into the blended gasoline feed in an amount sufficient to provide a 50 wppm sulfur level. FIG. 1 shows the gas composition, % dry, against time after introduction of the sulfated fuel, and FIG. 2 shows the time delay in the increase in hydrogen content of the product gas during sulfation of Catalyst 1 by the sulfated fuel. After 1700 hours of operation, the hydrogen production decreased less than 10%, thereby demonstrating that Catalyst 1 is both sulfur tolerant and coking resistant. The long term performance of Catalyst 1 is shown in FIG. 3.

### EXAMPLE 2

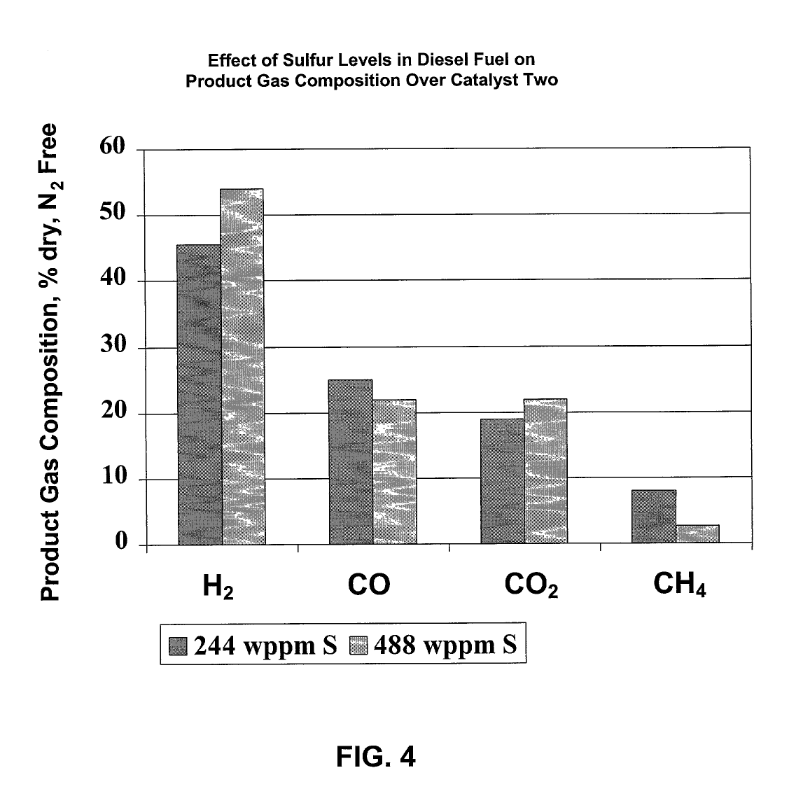

In this example, the sulfur tolerance and resistance of Catalyst 2 were demonstrated using H₂O, oxygen and diesel fuels having sulfur levels of 244 and 488 wppm at 800° C. The product gas composition is shown in FIG. 4. In addition to demonstrating the sulfur tolerance and coking resistance of the catalyst, it was found that an increased sulfur concentration in the fuel resulted in an increase in hydrogen yield (from 45.5 to 54.0% dry, N₂-free).

### EXAMPLE 3

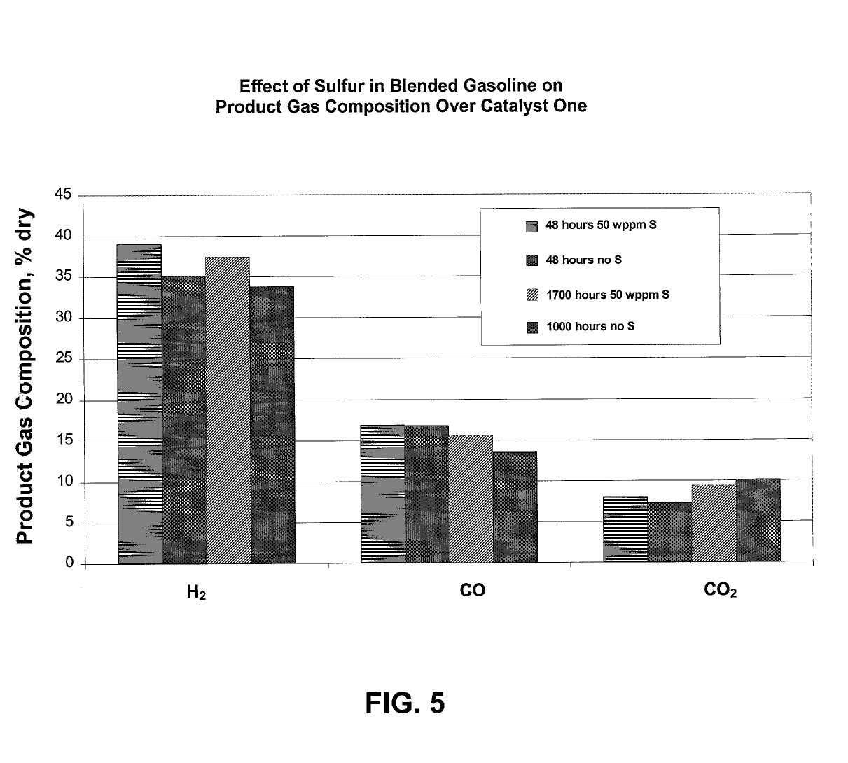

In this example, the test of Example 1 was repeated with the same blended gasoline, but without the benzothiophene. As shown in FIG. 5, the sulfur content in the carbonaceous fuel actually results in an increase in the hydrogen yield using Catalyst 1. For undoped blended gasoline, there was a 4% decrease in hydrogen production after 48 hours of operation. After 1000 hours of operation with the undoped blended gasoline, the hydrogen content had dropped to 34% compared to 37.5% after approximately 1700 hours of operation with sulfated blended gasoline.

### EXAMPLE 4

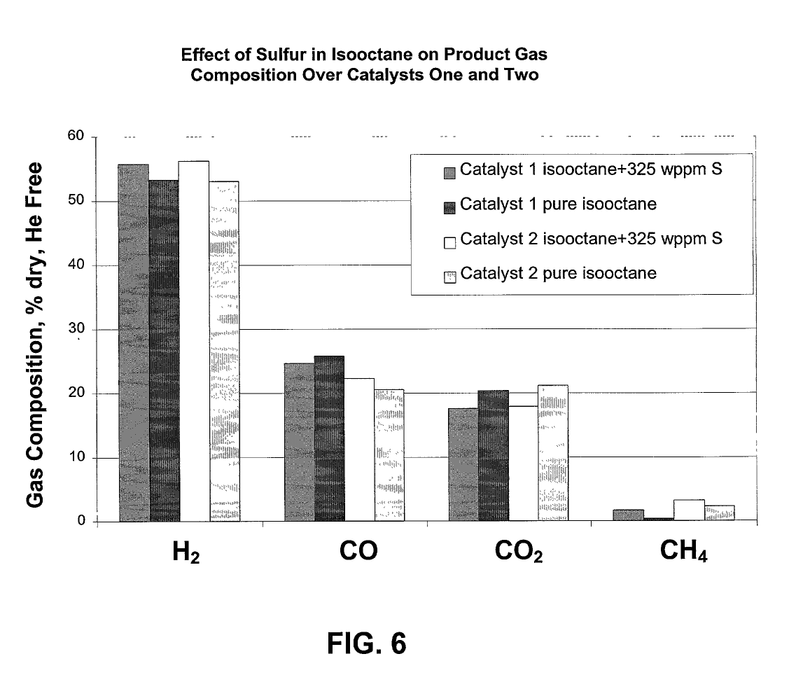

In this example, increases in hydrogen yield of sulfur-containing carbonaceous fuels over the autothermal hydrodesulfurizing reforming catalysts of this invention are further demonstrated using H₂O, oxygen, pure isooctane and isooctane doped with benzothiophene to provide a solution of 325 wppm sulfur level, with Catalyst 1 and Catalyst 2 under the operating conditions of Example 2. The results clearly show that the sulfur-containing isooctane provides higher hydrogen yield than the pure isooctane over both catalysts. The hydrogen yields increase from 53.2 to 55.8% (dry, He-free) for Catalyst 1 and from 53.1 to 56.3% (dry, He-free) for Catalyst 2, as shown in FIG. 6.

### EXAMPLE 5

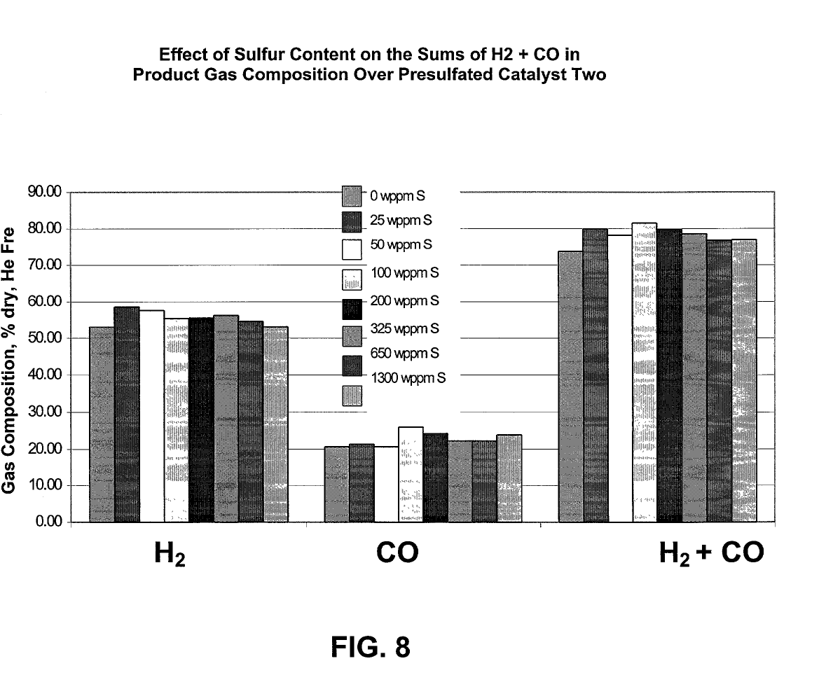

The test of Example 4 was repeated with isooctane doped with benzothiophene to provide sulfated fuels having sulfur levels in the range of about 25 to 1300 wppm over presulfated Catalyst 2 (FIG. 7). The results clearly show improved hydrogen yield at all fuel sulfur levels compared to the same catalyst and fuel stream where no sulfur is present. As shown in Table 1 hereinbelow, the hydrogen yield at 25 wppm S is 5.44% higher; at 100 wppm S, it is 2.34% higher; and at 325 wppm S, it is 3.17% higher than when no sulfur is present. However, because the bulk of the CO in the reformate is converted to additional hydrogen by way of the water-gas shift reaction, the sums of hydrogen and CO for all sulfur levels are plotted in FIG. 8. The results show that the yield of hydrogen and CO at 25 wppm S is 6.14% higher; at 100 wppm S it is 7.75% higher; and at 325 wppm it is 4.81% higher than when no sulfur is present.

TABLE 1
Hydrogen-rich Gas (% dry, He-free) Obtained from Autothermal
Hydrosulfurizing and Reforming of Carbonaceous Fuels with Sulfur
Levels from 25 to 1300 wppm over Presulfated Catalyst 2

| Sulfur level, wppm | 0 | 25 | 50 | 100 | 200 | 325 | 650 | 1300 |
|---|---|---|---|---|---|---|---|---|
| H₂ | 53.10 | 58.54 | 57.60 | 55.44 | 55.59 | 56.27 | 54.62 | 53.15 |
| CO | 20.61 | 21.31 | 20.61 | 26.02 | 24.22 | 22.25 | 22.21 | 23.86 |
| CO₂ | 21.20 | 18.79 | 20.67 | 15.81 | 16.42 | 17.88 | 19.29 | 18.86 |
| CH₄ | 2.32 | 1.27 | 1.04 | 2.43 | 3.43 | 3.31 | 3.35 | 3.50 |
| C₄H₉ | 0.06 | 0.04 | 0.05 | 0.05 | 0.06 | 0.06 | 0.34 | 0.21 |
| CₙHₘ, n > 4 | 2.71 | 0.05 | 0.03 | 0.25 | 0.28 | 0.23 | 0.19 | 0.42 |
| Total | 100.00 | 100.00 | 100.00 | 100.00 | 100.00 | 100.00 | 100.00 | 100.00 |
| H₂ + CO | 73.71 | 79.85 | 78.21 | 81.46 | 79.81 | 78.52 | 76.83 | 77.01 |

### EXAMPLE 6

In this example, the product gas composition data of isooctane plus 325 wppm sulfur using Catalyst 2 are compared with presulfated Catalyst 2. The results clearly show that no matter how the catalyst is sulfated, an equilibrium sulfur level is achieved on the catalyst surface during reforming, such that the catalyst surface is sulfated and maintained. Similar results are obtained with Catalyst 2 when the fuel is doped with the same sulfur level (FIG. 9). However, if the fuel does not contain sulfur, then the sulfur on the presulfated will eventually be lost during the reforming reaction in the form of gaseous H₂S.

Additional tests have been performed and the results show that sulfur levels in the carbonaceous fuels should be maintained in concentrations of less than about 1%, preferably less than about 1000 wppm, to improve the hydrogen yield.

While in the foregoing specification this invention has been described in relation to certain preferred embodiments thereof, and many details have been set forth for the purpose of illustration, it will be apparent to those skilled in the art that the invention is susceptible to additional embodiments and that certain of the details described herein can be varied considerably without departing from the basic principles of this invention.

We claim:

1. A catalyst composition comprising:
a dehydrogenation portion, an oxidation portion and a hydrodesulfurization portion, said catalyst composition being suitable for reforming a sulfur-containing carbonaceous fuel.

2. A catalyst composition in accordance with claim 1, wherein said dehydration portion comprises one of a metal and a metal alloy selected from the group consisting of Group VIII transition metals and mixtures thereof.

3. A catalyst composition in accordance with claim 1, wherein said oxidation portion comprises a ceramic oxide powder and a dopant selected from the group consisting of rare earth metals, alkaline earth metals, alkali metals and mixtures thereof.

4. A catalyst composition in accordance with claim 1, wherein said hydrodesulfurization portion comprises a material selected from the group consisting of Group IV rare earth metal sulfides, Group IV rare earth metal sulfates, their substoichiometric metals and mixtures thereof.

5. A catalyst composition in accordance with claim 1, wherein said catalyst composition is suitable for autothermal hydrodesulfurizing and reforming of sulfur-containing carbonaceous fuels.

6. A catalyst composition in accordance with claim 3, wherein said ceramic oxide powder comprises a material selected from the group consisting of ZrO₂, CeO₂, Bi₂O₃, BiVO₄, LaGdO₃ and mixtures thereof.

7. A catalyst composition in accordance with claim 1, wherein said catalyst composition is suitable for reforming said sulfur-containing carbonaceous fuel at a temperature less than about 1000° C.

8. A catalyst composition in accordance with claim 7, wherein said catalyst composition is suitable for reforming said sulfur-containing carbonaceous fuel at a temperature less than about 800° C.

9. A catalyst composition in accordance with claim 1, wherein said catalyst composition is suitable for reforming said sulfur-containing carbonaceous fuel at a pressure less than about 10 atmospheres.

10. A catalyst composition comprising:
a dehydrogenation portion comprising one of a metal and a metal alloy selected from the group consisting of Group VIII transition metals and mixtures thereof, an oxidation portion comprising a ceramic oxide powder and a dopant selected from the group consisting of rare earth metals, alkaline earth metals, alkali metals and mixtures thereof and a hydrodesulfurization portion comprising a material selected from the group consisting of Group IV rare earth metal sulfides, Group IV rare earth metal sulfates, their substoichiometric metals and mixtures thereof, said catalyst composition being suitable for reforming a sulfur-containing carbonaceous fuel.

11. A catalyst composition in accordance with claim 10, wherein said ceramic oxide powder comprises a material selected from the group consisting of ZrO₂, CeO₂, Bi₂O₃, BiVO₄, LaGdO₃ and mixtures thereof.

12. A catalyst composition comprising:
a dehydrogenation portion, an oxidation portion and a hydrodesulfurization portion, said catalyst composition being suitable for reforming a sulfur-containing carbonaceous fuel at a temperature of less than about 1000° C.

13. A catalyst composition in accordance with claim 12, wherein said catalyst composition is suitable for reforming said sulfur-containing carbonaceous fuel at a temperature less than about 800° C.
